(19) United States
(12) Patent Application Publication
(10) Pub. No.: US 2026/0241767 A1
(43) Pub. Date: Aug. 20, 2026

(54) THERMAL MANAGEMENT SYSTEM FOR A VEHICLE AND THE VEHICLE

(71) Applicant: TI Automotive Systems (Shanghai) Co., Ltd., Shanghai (CN)

(72) Inventors: Quanfu ZHANG, Shanghai (CN); Qi LIU, Shanghai (CN)

(21) Appl. No.: 19/539,929

(22) Filed: Feb. 13, 2026

(30) Foreign Application Priority Data
Feb. 14, 2025 (CN) 202520234093.8

(51) Int. Cl. B60H 1/00; F01P 7/16; H01M 10/613; H01M 10/625

(52) U.S. Cl. CPC B60H 1/00278; F01P 7/16; H01M 10/613; H01M 10/625; B60H 2001/00307; F01P 2060/08

(57) ABSTRACT

A thermal management system for a vehicle having a refrigerant circuit and a coolant circuit, the refrigerant circuit including a heat exchanger and a condenser which are fluidly connected, wherein the coolant circuit includes a multi-port switching valve and a proportional valve assembly, wherein the heat exchanger and the condenser are each fluidly connected to the multi-port switching valve; a plurality of loads are arranged in the coolant circuit, wherein at least part of the plurality of loads are fluidly connected to the multi-port switching valve via the proportional valve assembly, wherein the multi-port switching valve has multiple ports, and any two of the multiple ports can be mutually connected inside the multi-port switching valve. A vehicle having the aforementioned thermal management system is capable of achieving robust thermal management.

### RELATED APPLICATIONS

The present disclosure claims priority to and the benefit of Chinese Application 202520234093.8, filed on Feb. 14, 2025, the entire contents of each of which are incorporated herein by reference.

### FIELD

The present disclosure belongs to the technical field of vehicles, and more specifically relates to a thermal management system for a vehicle and a vehicle comprising such a thermal management system.

### BACKGROUND

At present, the penetration rate of new energy vehicles in China is continuously increasing. With the rising penetration of new energy vehicles, the proportion of their thermal management market within the overall automotive thermal management market is also rapidly growing. In the thermal management systems of new energy vehicles, functions such as refrigeration, heating, and heat recovery are typically integrated into a system. For example, some new energy vehicles adopt an integrated thermal management platform that uniformly plans and manages the thermal management requirements of components such as the traction battery, electric motor, and electronic controller.

During thermal management, piping and valve systems are involved. Current solutions for piping and valve systems are structurally complex, which is disadvantageous for achieving robust thermal management.

### BRIEF SUMMARY

Therefore, the present disclosure provides a thermal management system for a vehicle and a vehicle including such a thermal management system, wherein the thermal management system is capable of achieving robust thermal management.

According to a first aspect of the present disclosure, the above object is achieved by a thermal management system for a vehicle, thermal management system comprising a refrigerant circuit and a coolant circuit, the refrigerant circuit including a heat exchanger and a condenser which are fluidly connected, wherein the coolant circuit includes a multi-port switching valve and a proportional valve assembly, wherein the heat exchanger and the condenser are each fluidly connected to the multi-port switching valve; wherein a plurality of loads are arranged in the coolant circuit, wherein at least part of the plurality of loads are fluidly connected to the multi-port switching valve via the proportional valve assembly, wherein the multi-port switching valve has multiple ports, wherein any two of the multiple ports can be mutually connected inside the multi-port switching valve.

By providing a multi-port switching valve and a proportional valve assembly according to the present disclosure, the switching function and the proportional control function can be implemented separately by the multi-port switching valve and the proportional valve assembly, respectively. Consequently, both the multi-port switching valve and the proportional valve assembly can be designed with simpler structures, thus the thermal management system according to the present disclosure is less prone to failure and thereby achieving robust thermal management.

In some embodiments, the plurality of loads include a traction battery and a cold core for a passenger compartment of the vehicle, wherein the proportional valve assembly includes a first proportional valve, wherein the traction battery and the cold core are fluidly connected to the multi-port switching valve via the first proportional valve on the inflow side, wherein the first proportional valve is arranged upstream of the traction battery and the cold core along the flow direction of the coolant, wherein the first proportional valve has at least one inlet and at least two outlets, wherein two of the at least two outlets are respectively dedicated to the traction battery and the cold core. Thus, in the present disclosure, the coolant flow rates entering the traction battery and the cold core can be regulated by a single first proportional valve, thereby advantageously enabling temperature regulation of the traction battery and the cold core.

In some embodiments, the first proportional valve is configured as a three-way proportional valve.

In some embodiments, the traction battery and the cold core are arranged in parallel to form a parallel structure, wherein the parallel structure includes a first branch conduit and a second branch conduit, wherein the coolant circuit includes a first inflow conduit and a first return conduit, the first inflow conduit and the first return conduit are fluidly connected to the multi-port switching valve, wherein the first branch conduit and the second branch conduit branch off from the first inflow conduit at a first branching point on the inflow side and converge into the first return conduit at a second branching point on the return side, wherein the cold core is arranged on the first branch conduit, wherein the traction battery is arranged on the second branch conduit, wherein the first proportional valve is arranged at the first branching point on the inflow side, wherein one end of the first branch conduit and one end of the second branch conduit are respectively connected to corresponding outlets of the first proportional valve and the other ends thereof converge at the second branching point. Thus, favorable thermal management of the cold core and the traction battery is achieved.

In some embodiments, one end of the first inflow conduit is connected to a corresponding port of the multi-port switching valve and the other end thereof is connected to a corresponding inlet of the first proportional valve, wherein one end of the first return conduit is connected to a corresponding port of the multi-port switching valve.

In some embodiments, a first bypass conduit bypassing the traction battery is provided on the second branch conduit, wherein one end of the first bypass conduit is connected between the first branching point and the traction battery, and the other end thereof is connected between the traction battery and the second branching point, thereby forming a traction battery-bypass branching point, and wherein a bypass-proportional valve is arranged at the battery-bypass branching point. Thus, the first bypass conduit and the section of the second branch conduit where the traction battery is located together form a coolant circuit for the traction battery, thereby enabling internal circulation of coolant for the traction battery. This coolant circuit for the traction battery can regulate not only the inlet temperature of the coolant but also the thermal balance of the traction battery.

In some embodiments, the bypass-proportional valve is configured as a three-way proportional valve.

In some embodiments, the plurality of loads further include a hot core for the passenger compartment of the vehicle, wherein the hot core is also fluidly connected to the multi-port switching valve via the first proportional valve on the inflow side, wherein the first proportional valve is arranged upstream of the hot core along the flow direction of the coolant, wherein the first proportional valve has at least two inlets and at least three outlets, wherein three of the at least three outlets are respectively dedicated to the traction battery, the cold core, and the hot core. The first proportional valve can realize at least three positions, each position being connected to a corresponding conduit and isolated from the other conduits. Thus, the cooling mode and heating mode for both the traction battery and the passenger compartment can be advantageously implemented via a single first proportional valve by switching among different positions.

In some embodiments, the first proportional valve is configured as a three-position five-way proportional valve.

In some embodiments, the coolant circuit includes a second inflow conduit and a third branch conduit, wherein one end of the second inflow conduit is connected to a corresponding port of the multi-port switching valve and the other end thereof is connected to a corresponding inlet of the first proportional valve, wherein one end of the third branch conduit is connected to a corresponding outlet of the first proportional valve and the other end thereof is either connected to a corresponding port of the multi-port switching valve or connected to a condenser-inflow conduit extending from a port of the multi-port switching valve toward the condenser, wherein the hot core is arranged on the third branch conduit.

In some embodiments, the plurality of loads further includes a hot core for the passenger compartment of the vehicle, wherein the proportional valve assembly includes a second proportional valve, wherein the second proportional valve is arranged upstream of the hot core along the flow direction of the coolant. By providing a separate second proportional valve for the hot core, temperature regulation of the traction battery and the cold core can be achieved via the first proportional valve, while temperature regulation of the hot core can be achieved via the second proportional valve. Thus, for the first proportional valve and the second proportional valve, a relatively simple structural form can be adopted; accordingly, on the one hand, the first proportional valve and the second proportional valve have lower cost, and on the other hand, their control is also relatively simple, thereby making them more robust.

In some embodiments, the coolant circuit includes a third inflow conduit and a second return conduit, wherein the hot core is arranged on the second return conduit, wherein the hot core is fluidly connected to the multi-port switching valve via the second proportional valve on the inflow side, wherein the second proportional valve has at least one inlet and at least one outlet, wherein one end of the third inflow conduit is connected to a corresponding port of the multi-port switching valve and the other end thereof is connected to a corresponding inlet of the second proportional valve, while one end of the second return conduit is connected to a corresponding outlet of the second proportional valve and the other end thereof is either connected to a corresponding port of the multi-port switching valve or connected to a condenser-inflow conduit extending from a port of the multi-port switching valve toward the condenser, or wherein the hot core is fluidly connected to the condenser via the second proportional valve on the inflow side, wherein the second proportional valve has at least one inlet and at least two outlets, wherein the second proportional valve is arranged on a condenser-outflow conduit extending from the condenser toward a port of the multi-port switching valve, the third inflow conduit is formed by a segment of the condenser-outflow conduit, wherein one end of the third inflow conduit is connected to the outlet of the condenser directed toward the multi-port switching valve and the other end thereof is connected to a corresponding inlet of the second proportional valve, while one end of the second return conduit is connected to a corresponding outlet of the second proportional valve and the other end thereof is either connected to a corresponding port of the multi-port switching valve or connected to a condenser-inflow conduit extending from a port of the multi-port switching valve toward the condenser. When the hot core is fluidly connected to the multi-port switching valve via the second proportional valve on the inflow side, the pipeline connection logic is clearer, thereby making maintenance or repair more convenient in the future. When the hot core is fluidly connected to the condenser via the second proportional valve on the inflow side, a corresponding port of the multi-port switching valve can be omitted. In particular, when the second return conduit is connected to the condenser-inflow conduit extending from a port of the multi-port switching valve toward the condenser, no dedicated port for the hot core needs to be provided on the multi-port switching valve. When the number of ports of the multi-port switching valve required for operation is reduced, better control of the multi-port switching valve can be achieved.

In some embodiments, the hot core is fluidly connected to the multi-port switching valve via the second proportional valve on the inflow side, wherein the second proportional valve has at least one inlet and at least two outlets, wherein the coolant circuit further includes a fourth branch conduit, one end of which is connected to a corresponding outlet of the second proportional valve and the other end of which is connected to the second branch conduit.

In some embodiments, a heater is arranged on the condenser-outflow conduit, and when the hot core is fluidly connected to the condenser via the second proportional valve on the inflow side, the heater is arranged between the condenser and the second proportional valve.

In some embodiments, the second proportional valve is configured as a three-way proportional valve.

In some embodiments, the coolant circuit includes a waste-heat-recovery-cooling conduit, both ends of which are respectively connected to corresponding ports of the multi-port switching valve, wherein a radiator is arranged on the waste-heat-recovery-cooling conduit.

In some embodiments, a drive motor is also arranged on the waste-heat-recovery-cooling conduit, the drive motor being arranged either upstream or downstream of the radiator along the flow direction of the coolant on the waste-heat-recovery-cooling conduit.

In some embodiments, the coolant circuit includes a second bypass conduit, which bypasses the radiator. Thus, flexible switching between two modes—recovering waste heat from both the radiator and the drive motor, and recovering waste heat only from the drive motor—can be achieved, thereby enabling richer operational modes. Additionally, at least one port of the multi-port switching valve can be omitted, thereby forming a more compact multi-port switching valve structure.

In some embodiments, one end of the second bypass conduit is connected to a corresponding port of the multi-port switching valve and the other end thereof is connected to the waste-heat-recovery-cooling conduit between the radiator and the drive motor, thereby forming a first radiator-bypass branching point at the connection point between the second bypass conduit and the waste-heat-recovery-cooling conduit. Thus, flexible switching between the two modes—recovering waste heat from both the radiator and the drive motor, and recovering waste heat only from the drive motor—can be achieved, thereby enabling richer operational modes. Additionally, one port of the multi-port switching valve can be omitted.

In some embodiments, one end of the second bypass conduit is connected to the waste-heat-recovery-cooling conduit between the inflow-side port of the multi-port switching valve and the radiator, and the other end thereof is connected to the waste-heat-recovery-cooling conduit between the radiator and the drive motor, thereby correspondingly forming a second radiator-bypass branching point on the inflow side and a third radiator-bypass branching point on the return side at the respective connection points between the second bypass conduit and the waste-heat-recovery-cooling conduit, wherein a bypass-switching valve is arranged at the second radiator-bypass branching point. Thus, flexible switching between the two modes—recovering waste heat from both the radiator and the drive motor, and recovering waste heat only from the drive motor—can be achieved, thereby enabling richer operational modes. Additionally, two ports of the multi-port switching valve can be omitted.

In some embodiments, the bypass-switching valve is configured as a three-way switching valve.

In some embodiments, a first temperature sensor is arranged upstream or downstream of the traction battery along the flow direction of the coolant, the first temperature sensor being configured to detect the temperature of the coolant flowing toward or exiting from the traction battery; and/or a second temperature sensor is arranged upstream of the cold core along the flow direction of the coolant, the second temperature sensor being configured to detect the temperature of the coolant flowing toward the cold core. Thus, favorable detection of the coolant temperature flowing through the traction battery and/or the cold core is achieved.

In some embodiments, a third temperature sensor is arranged upstream of the hot core along the flow direction of the coolant, the third temperature sensor being configured to detect the temperature of the coolant flowing toward the hot core. Thus, favorable detection of the coolant temperature flowing toward the hot core is achieved.

In some embodiments, a fourth temperature sensor is arranged upstream of the drive motor along the flow direction of the coolant, the fourth temperature sensor being configured to detect the temperature of the coolant flowing toward the drive motor, wherein the drive motor is arranged downstream of the first radiator-bypass branching point on the waste-heat-recovery-cooling conduit along the flow direction of the coolant, wherein the fourth temperature sensor is arranged between the first radiator-bypass branching point and the drive motor. Thus, favorable detection of the coolant temperature flowing toward the drive motor is achieved.

In some embodiments, a fifth temperature sensor is arranged upstream of the drive motor along the flow direction of the coolant, the fifth temperature sensor being configured to detect the temperature of the coolant flowing toward the drive motor, wherein the drive motor is arranged downstream of the third radiator-bypass branching point on the waste-heat-recovery-cooling conduit along the flow direction of the coolant, wherein the fifth temperature sensor is arranged between the third radiator-bypass branching point and the drive motor. Thus, favorable detection of the coolant temperature flowing toward the drive motor is achieved.

In some embodiments, the thermal management system includes a coolant reservoir, wherein a coolant supply conduit extending from the coolant reservoir is connected to a condenser-inflow conduit extending from a port of the multi-port switching valve toward the condenser, and/or connected to a heat-exchanger-inflow conduit extending from a port of the multi-port switching valve toward the heat exchanger, and/or connected to the second branch conduit upstream of the traction battery along the flow direction of the coolant.

According to a second aspect of the present disclosure, the above object can also be achieved by a vehicle, which comprises the thermal management system according to the present disclosure.

### BRIEF DESCRIPTION OF THE DRAWINGS

The present disclosure will be further described below with reference to schematic drawings and exemplary embodiments:

FIG. 1 is a schematic structural diagram of a thermal management system according to a first embodiment of the present disclosure.

FIG. 2 is a schematic structural diagram of a thermal management system according to a second embodiment of the present disclosure.

FIG. 3 is a schematic structural diagram of a thermal management system according to a third embodiment of the present disclosure.

FIG. 4 is a schematic structural diagram of a thermal management system according to a fourth embodiment of the present disclosure.

FIG. 5 is a schematic structural diagram of a thermal management system according to a fifth embodiment of the present disclosure.

FIG. 6 is a schematic structural diagram of a thermal management system according to a sixth embodiment of the present disclosure.

### DETAILED DESCRIPTION

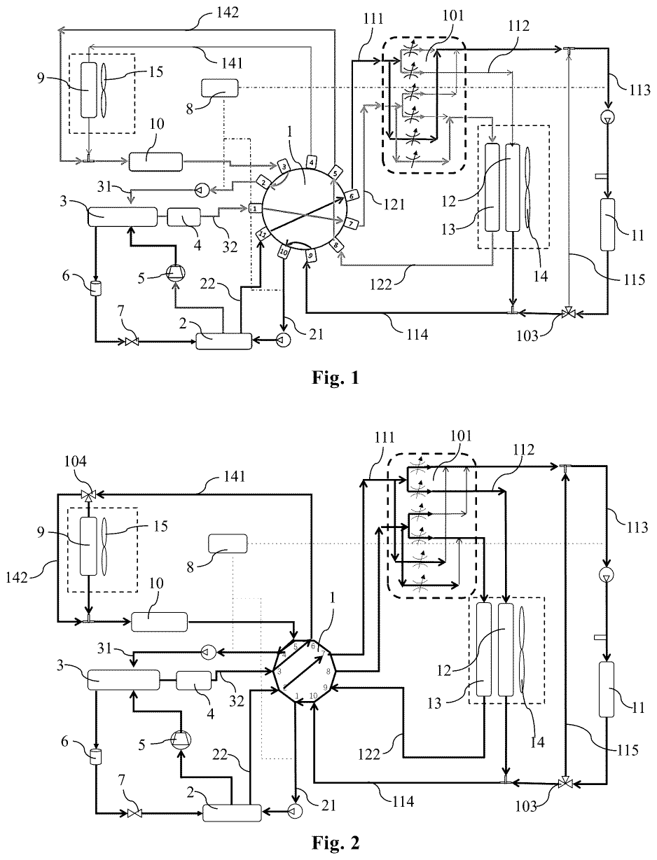

The thermal management system according to the first embodiment of the present disclosure will first be described below with reference to FIG. 1.

As shown in FIG. 1, the thermal management system according to the first embodiment includes a refrigerant circuit and a coolant circuit. The coolant circuit includes a multi-port switching valve 1. In the first embodiment, the multi-port switching valve 1 is configured as an eleven-way switching valve, which has eleven ports, and any two of these eleven ports can be mutually connected inside the multi-port switching valve 1. It should be emphasized here that the naming convention for the various ports of the multi-port switching valve 1 in this document is merely illustrative. Moreover, the correspondence between the various components or devices of the thermal management system and the ports of the multi-port switching valve 1 is also merely illustrative, and those skilled in the art may interchange the connected ports as needed.

The arrangement of the refrigerant circuit will first be described. The refrigerant circuit includes a heat exchanger 2 and a condenser 3. The heat exchanger 2 may be configured as a cold plate heat exchanger. The condenser 3 may be configured as a water-cooled condenser 3. On one hand, the heat exchanger 2 is fluidly connected to the tenth port of the eleven-way switching valve via a heat-exchanger-inflow conduit 21 extending from the tenth port of the eleven-way switching valve to the heat exchanger 2; on the other hand, it is fluidly connected to the eleventh port of the eleven-way switching valve via a heat-exchanger-outflow conduit 22 extending from the heat exchanger 2 to the eleventh port of the eleven-way switching valve. On one hand, the condenser 3 is fluidly connected to the first port of the eleven-way switching valve via a condenser-outflow conduit 32 extending from the condenser 3 to the first port of the eleven-way switching valve; on the other hand, it is fluidly connected to the second port of the eleven-way switching valve via a condenser-inflow conduit 31 extending from the second port of the eleven-way switching valve to the condenser 3. A heater 4 is arranged on the condenser-outflow conduit 32. Here, the heater 4 may be configured as an electric heater to enable precise setting of heating time and temperature. Within the refrigerant circuit, the heat exchanger 2 and the condenser 3 are also fluidly connected to each other, wherein the heat exchanger 2 is connected to the condenser 3 via a first connecting conduit extending from the heat exchanger 2 to the condenser 3 and a second connecting conduit extending from the condenser 3 to the heat exchanger 2. A compressor 5 is arranged on the first connecting conduit. The compressor 5 is configured as an electric compressor. Along the flow direction of the refrigerant on the second connecting conduit, a liquid storage tank 6 and a throttle valve 7 are sequentially arranged. The throttle valve 7 may be configured as an electronic expansion valve. In the present disclosure, the refrigerant may be R290.

To store and supply coolant, a coolant reservoir 8 may be provided. In the present disclosure, the coolant may be water. The coolant reservoir 8 may be configured as a water tank. Of course, other suitable coolants and corresponding coolant reservoirs 8 may also be envisioned. As can be seen from FIG. 1, the coolant supply conduit extending from the coolant reservoir 8 is connected to the condenser-inflow conduit 31 and also to the heat-exchanger-inflow conduit 21.

To heat or raise the temperature of the coolant, the coolant may flow sequentially through the condenser 3 and the heater 4. The heated coolant can then enter the multi-port switching valve 1 for heating components that require heating.

To cool or lower the temperature of the coolant, the coolant may flow through the heat exchanger 2. The cooled coolant can then enter the multi-port switching valve 1 for cooling components that require cooling.

As can be seen from FIG. 1, apart from the multi-port switching valve 1, the coolant circuit also includes a proportional valve assembly. The term “proportional valve assembly” refers to a proportional valve arrangement, which may be configured as a single multi-port proportional valve or may include multiple separately arranged multi-port proportional valves. Moreover, a plurality of loads is arranged in the coolant circuit. In the present disclosure, the term “load” particularly refers to components requiring temperature regulation. As shown in FIG. 1, the plurality of loads includes a traction battery 11, a cold core 12 for the passenger compartment of the vehicle, and a hot core 13 for the passenger compartment of the vehicle. The proportional valve assembly includes a first proportional valve 101, wherein the traction battery 11, the cold core 12, and the hot core 13 are fluidly connected to the multi-port switching valve 1 via the first proportional valve 101 on the inflow side, wherein the first proportional valve 101 is arranged upstream of the traction battery 11, the cold core 12, and the hot core 13 along the flow direction of the coolant. The first proportional valve 101 is configured as a three-position five-way proportional valve, wherein three outlets of the three-position five-way proportional valve are respectively dedicated to the traction battery 11, the cold core 12, and the hot core 13. Thus, the proportional valve functions for the traction battery 11, the cold core 12, and the hot core 13 are implemented by only one three-position five-way proportional valve. Apart from the three-position five-way proportional valve, other multi-port proportional valves may also be envisioned.

As clearly shown in FIG. 1, the traction battery 11 and the cold core 12 are arranged in parallel to form a parallel structure, which includes a first branch conduit 112 and a second branch conduit 113. The coolant circuit further includes a first inflow conduit 111 and a first return conduit 114, wherein the first inflow conduit 111 and the first return conduit 114 are fluidly connected to the multi-port switching valve 1. The first branch conduit 112 and the second branch conduit 113 branch off from the first inflow conduit 111 at a first branching point on the inflow side and converge into the first return conduit 114 at a second branching point on the return side, wherein the cold core 12 is arranged on the first branch conduit 112, wherein the traction battery 11 is arranged on the second branch conduit 113. The first proportional valve 101 is arranged at the first branching point on the inflow side. One end of the first branch conduit 112 and one end of the second branch conduit 113 are respectively connected to corresponding outlets of the first proportional valve 101, and the other ends thereof converge at the second branching point. The first inflow conduit, the first branch conduit 112, and the second branch conduit 113 occupy three ports, namely one inlet and two outlets, of the three-position five-way proportional valve respectively. In addition, the coolant circuit further includes a second inflow conduit 121 and a third branch conduit 122, wherein the hot core 13 is arranged on the third branch conduit 122. The second inflow conduit 121 occupies one inlet of the three-position five-way proportional valve, and the third branch conduit 122 occupies one outlet of the three-position five-way proportional valve. The first branch conduit 112 and the second branch conduit 113 converge at the second branching point and then return to the multi-port switching valve 1 via the first return conduit 114. The connections of these conduits to the multi-port switching valve 1 are as follows: one end of the first inflow conduit 111 is connected to the sixth port of the multi-port switching valve 1; one end of the second inflow conduit 121 is connected to the seventh port of the multi-port switching valve 1; one end of the third branch conduit 122 for the hot core 13 is connected to the eighth port of the multi-port switching valve 1; and one end of the first return conduit 114 for the first branch conduit 112 for the cold core 12 and the second branch conduit 113 for the traction battery 11 is connected to the ninth port of the multi-port switching valve 1.

Alternatively, in an unillustrated embodiment, the end of the third branch conduit 122 that would otherwise be connected to a port of the multi-port switching valve 1 may instead be connected to the condenser-inflow conduit 31 extending from a port of the multi-port switching valve 1 toward the condenser 3.

To implement an internal circulation for thermal management of the traction battery 11, a first bypass conduit 115 bypassing the traction battery 11 is provided on the second branch conduit 113. One end of the first bypass conduit 115 is connected between the first branching point and the traction battery 11. The other end of the first bypass conduit 115 is connected between the traction battery 11 and the second branching point, thereby forming a traction battery-bypass branching point, at which a bypass-proportional valve 103 is arranged. Here, the bypass-proportional valve 103 is configured as a three-way proportional valve. Thus, when needed, the coolant can flow within the circulation loop formed by the first bypass conduit 115 and the section of the second branch conduit 113 where the traction battery 11 is located. Moreover, to achieve precise detection of the coolant temperature flowing toward the traction battery 11 and thereby enable precise temperature regulation of the traction battery 11, a first temperature sensor is arranged upstream of the traction battery 11 along the flow direction of the coolant.

In the present disclosure, the cold core 12 and the hot core 13 are primarily used for cabin temperature regulation. Of course, for this purpose, the cold core 12 and the hot core 13 are also equipped with a blower device 14 to blow cold air and hot air into the passenger compartment for cabin air conditioning.

Drive motors 10 are typically present in new energy vehicles. The drive motor 10 generates heat during stall and driving conditions, and this heat can be recovered as waste heat. Additionally, during vehicle operation, the drive motor 10 needs to be cooled by a radiator 9. Here, the waste heat from the drive motor 10 can be utilized, or the drive motor 10 can be cooled via the radiator 9. As shown in FIG. 1, the coolant circuit includes a waste-heat-recovery-cooling conduit 141, both ends of which are respectively connected to corresponding ports—namely the third port and the fourth port—of the multi-port switching valve 1, wherein a radiator 9 and a drive motor 10 are arranged on the waste-heat-recovery-cooling conduit 141, wherein the drive motor 10 is arranged downstream of the radiator 9 along the flow direction of the coolant on the waste-heat-recovery-cooling conduit 141. A fan 15 can also be seen in FIG. 1, which is used for cooling the radiator 9.

To enable richer operational modes, the coolant circuit further includes a second bypass conduit 142, which is arranged to bypass the radiator 9. Thus, switching between two modes—“coolant flows only through the drive motor 10” and “coolant flows through both the drive motor 10 and the radiator 9”—can be achieved as needed. Consequently, the entire system can realize the function of dissipating heat via the radiator 9 for cooling. Moreover, by selectively bypassing the radiator, either an air-source heat pump function or a waste heat recovery heating function utilizing the waste heat from the traction battery and the drive motor 10 can be realized.

Specifically, one end of the second bypass conduit 142 is connected to the fifth port of the multi-port switching valve 1, and the other end thereof is connected to the waste-heat-recovery-cooling conduit 141 between the radiator 9 and the drive motor 10, thereby forming a first radiator-bypass branching point at the connection point between the second bypass conduit 142 and the waste-heat-recovery-cooling conduit 141. Thus, the conduits involving the radiator 9 and the drive motor 10 occupy only three ports of the multi-port switching valve 1. Compared with the conventional approach of providing separate conduits for the radiator 9 and the drive motor 10, which would occupy four ports of the multi-port switching valve 1, the present embodiment saves one port of the multi-port switching valve 1. Moreover, the arrangement of the second bypass conduit 142 in the first embodiment does not require an additional switching valve; the corresponding switching valve function is implemented by the multi-port switching valve 1. This can save costs on one hand, and on the other hand, it also eliminates a potential failure point.

Besides the arrangement where the drive motor 10 is positioned downstream of the radiator 9, it is also conceivable to arrange the drive motor 10 upstream of the radiator 9 along the flow direction of the coolant. In this case, for example, the flow direction indicated by the arrows in FIG. 1 could be reversed. Such an arrangement can also achieve the radiator bypass function.

The operating principle of the thermal management system according to the first embodiment will now be described with reference to the internal connection schematic lines of the multi-port switching valve 1 and the first proportional valve 101 shown in FIG. 1. Water is exemplarily used as the coolant for illustration purposes.

As shown in FIG. 1, the eleventh port of the multi-port switching valve 1 is connected to the sixth port, thereby supplying chilled water cooled by the heat exchanger 2 to the first inflow conduit 111. The first port of the multi-port switching valve 1 is connected to the seventh port, thereby supplying heated water heated by the condenser 3 and the heater 4 to the second inflow conduit 121. The chilled water and heated water then enter the three-position five-way proportional valve via two inlets thereof. By switching the internal channels of the three-position five-way proportional valve, three positions or functions—namely heating position, cooling-heating position, and cooling position—can be achieved. Thus, for example, heated water and chilled water can be supplied to the hot core 13, the cold core 12, and the traction battery 11 as required, with the flow rates regulated by the first proportional valve 101. Heated water can be introduced into the hot core 13 to heat it; chilled water can be introduced into the cold core 12 to cool it; heated water can be introduced into the traction battery 11 to heat it (e.g., when the ambient temperature is low, the traction battery 11 needs to be preheated before use to quickly bring it to its optimal operating temperature); or chilled water can be introduced into the traction battery 11 to cool it. Moreover, as can be seen from FIG. 1, the ninth port of the multi-port switching valve 1 is connected to the tenth port, so that for example the used chilled water for the cold core 12 and/or the traction battery 11, or the used heated water for the traction battery 11, can return via the first return conduit 114 and the multi-port switching valve 1 back to the heat exchanger 2. Additionally, the eighth port of the multi-port switching valve 1 is connected to the fifth port, and the third port of the multi-port switching valve 1 is connected to the second port, so that the used heated water for the hot core 13 flows via the second bypass conduit 142 to the drive motor 10 and then back to the condenser 3, thereby achieving waste heat recovery. In an unillustrated embodiment, the ninth port of the multi-port switching valve 1 could alternatively be connected to the fourth port, and the third port could be connected to the tenth port, so that the chilled water, after passing through the cold core 12 and/or the traction battery 11, could then cool the drive motor 10 before returning to the heat exchanger 2. In this case, the eighth port of the multi-port switching valve 1 could be directly connected to the second port, wherein the heated water, after passing through the hot core 13, returns to the condenser 3 without recovering waste heat.

The thermal management system according to the second embodiment of the present disclosure will now be described with reference to FIG. 2.

The thermal management system according to the second embodiment is substantially identical in arrangement to that of the first embodiment. Reference may be made to the description of the first embodiment for the aforementioned structure. Here, the difference lies in the connection method of the second bypass conduit 142 and the related arrangement structure. The distinction will be mainly described below.

As shown in FIG. 2, in the second embodiment, the coolant circuit includes a waste-heat-recovery-cooling conduit 141, both ends of which are respectively connected to corresponding ports—namely the fifth port and the sixth port—of the multi-port switching valve 1, wherein a radiator 9 and a drive motor 10 are similarly arranged on the waste-heat-recovery-cooling conduit 141, wherein the drive motor 10 is also arranged downstream of the radiator 9 along the flow direction of the coolant on the waste-heat-recovery-cooling conduit 141. Similarly, to enable richer operational modes, the coolant circuit further includes a second bypass conduit 142, which is arranged to bypass the radiator 9. In this second embodiment, one end of the second bypass conduit 142 is connected to the waste-heat-recovery-cooling conduit 141 between the sixth port of the multi-port switching valve 1 and the radiator 9, and the other end thereof is connected to the waste-heat-recovery-cooling conduit 141 between the radiator 9 and the drive motor 10, thereby correspondingly forming a second radiator-bypass branching point on the inflow side and a third radiator-bypass branching point on the return side at the respective connection points between the second bypass conduit 142 and the waste-heat-recovery-cooling conduit 141. A bypass-switching valve 104 is arranged at the second radiator-bypass branching point. The bypass-switching valve 104 may be configured as a three-way switching valve. Thus, flexible switching between the two modes—“coolant flows only through the drive motor 10” and “coolant flows through both the drive motor 10 and the radiator 9”—can also be achieved. By additionally providing a bypass-switching valve 104, one more port of the multi-port switching valve 1 can be saved compared to the first embodiment. Consequently, in the second embodiment, unlike the first embodiment, a ten-port switching valve can be used as the multi-port switching valve 1.

Besides the arrangement where the drive motor 10 is arranged downstream of the radiator 9, it is also conceivable here to arrange the drive motor 10 upstream of the radiator 9 along the flow direction of the coolant. In this case, for example, the flow direction indicated by the arrows in FIG. 2 could be reversed. In this case, the side of the fifth port of the multi-port switching valve 1 would be the inflow side. The bypass-switching valve 104 would then be arranged at the radiator-bypass branching point closer to the fifth port.

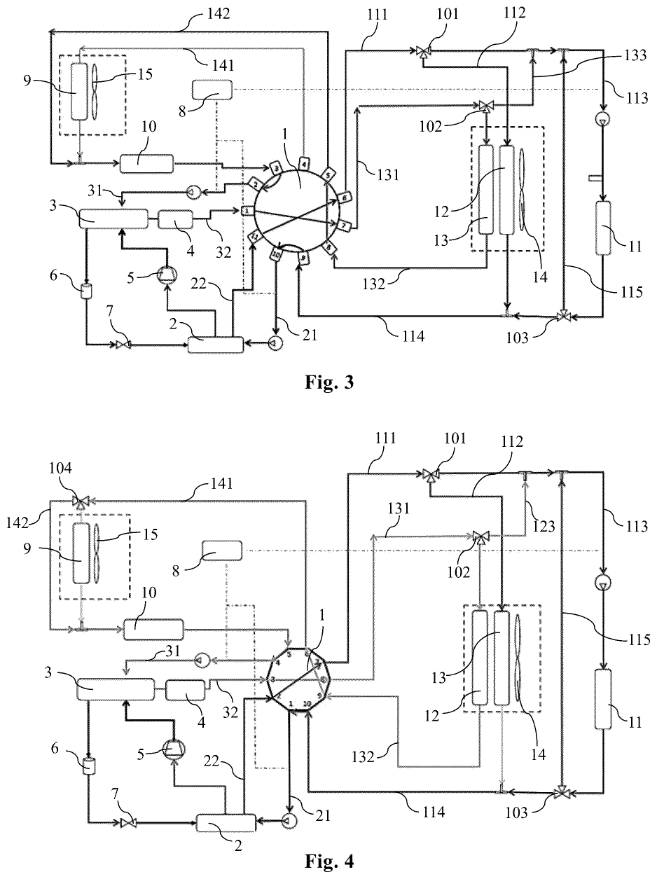

The thermal management system according to the third embodiment of the present disclosure will now be described with reference to FIG. 3.

The thermal management system according to the third embodiment is substantially identical to that of the first embodiment with respect to the refrigerant circuit, the multi-port switching valve 1, and the arrangement structure for waste-heat-recovery-cooling. Reference may be made to the description of the first embodiment for the aforementioned structure. The difference lies in the arrangement structure of the proportional valve assembly. The distinction will be mainly described below.

In the third embodiment, the multi-port switching valve 1 is also configured as an eleven-way valve. A plurality of loads is also arranged in the coolant circuit, wherein the plurality of loads includes a traction battery 11, a cold core 12 for the passenger compartment of the vehicle, and a hot core 13 for the passenger compartment of the vehicle. The proportional valve assembly includes a first proportional valve 101 and a second proportional valve 102. The traction battery 11 and the cold core 12 are fluidly connected to the multi-port switching valve 1 via the first proportional valve 101 on the inflow side, wherein the first proportional valve 101 is arranged upstream of the traction battery 11 and the cold core 12 along the flow direction of the coolant. The second proportional valve 102 is also arranged upstream of the hot core 13 along the flow direction of the coolant. In this third embodiment, the first proportional valve 101 and the second proportional valve 102 are configured as three-way proportional valves respectively. The two outlets of the first proportional valve 101, configured as a three-way proportional valve, are respectively dedicated to the traction battery 11 and the cold core 12, while one of the two outlets of the second proportional valve 102, configured as a three-way proportional valve, can be used for the hot core 13, and the other outlet can be blocked or connected to a conduit related to the traction battery 11. It should be noted that besides being configured as a three-way or higher-way proportional valve, the second proportional valve 102 may also be configured as a two-way proportional valve, wherein one outlet of the two-way proportional valve is dedicated to the hot core 13. Unlike the integrated proportional valve solution of the first embodiment, in the third embodiment, the first proportional valve 101 and the second proportional valve 102 are arranged separately. This makes control easier compared to the first embodiment. Moreover, the first proportional valve 101 and the second proportional valve 102 of this embodiment are structurally simpler than the first proportional valve 101 of the first embodiment, thus being less prone to failure and consequently more robust.

Specifically, as clearly shown in FIG. 3, the traction battery 11 and the cold core 12 are arranged in parallel to form a parallel structure, which includes a first branch conduit 112 and a second branch conduit 113. The coolant circuit includes a first inflow conduit 111 and a first return conduit 114, wherein the first inflow conduit 111 and the first return conduit 114 are fluidly connected to the multi-port switching valve 1, wherein first branch conduit 112 and the second branch conduit 113 branch off from the first inflow conduit 111 at a first branching point on the inflow side and converge into the first return conduit 114 at a second branching point on the return side, wherein the cold core 12 is arranged on the first branch conduit 112, and the traction battery 11 is arranged on the second branch conduit 113. The first proportional valve 101 is arranged at the first branching point on the inflow side. One end of the first branch conduit 112 and one end of the second branch conduit 113 are respectively connected to corresponding outlets of the first proportional valve 101, and the other ends thereof converge at the second branching point. The first inflow conduit, the first branch conduit 112, and the second branch conduit 113 occupy the three ports, namely one inlet and two outlets, of the first proportional valve 101, which is configured as a three-way proportional valve, respectively. In addition, the coolant circuit further includes a third inflow conduit 131 and a second return conduit 132, wherein the hot core 13 is arranged on the second return conduit 132. In this embodiment, the hot core 13 is fluidly connected to the multi-port switching valve 1 via the second proportional valve 102 on the inflow side. The third inflow conduit 131 occupies one inlet of the second proportional valve 102, configured as a three-way proportional valve, and the second return conduit 132 occupies one outlet of the second proportional valve 102. To utilize the extra outlet of the second proportional valve 102, the coolant circuit further includes a fourth branch conduit 133. One end of the fourth branch conduit 133 is connected to the other outlet of the second proportional valve 102, and the other end thereof is connected to the second branch conduit 113, particularly connected between the first proportional valve 101 and the first branching point on the second branch conduit 113. Of course, as mentioned above, the fourth branch conduit 133 may also not be provided. In this case, the second proportional valve 102 may be configured as a two-way proportional valve, or if the second proportional valve 102 is configured as a three-way proportional valve, the unused outlet may be blocked.

In the third embodiment, the connections of the conduits to the multi-port switching valve 1 are as follows: one end of the first inflow conduit 111 is connected to the sixth port of the multi-port switching valve 1; one end of the third inflow conduit 131 is connected to the seventh port of the multi-port switching valve 1; one end of the second return conduit 132 for the hot core 13 is connected to the eighth port of the multi-port switching valve 1; and one end of the first return conduit 114 for the first branch conduit 112 for the cold core 12 and the second branch conduit 113 for the traction battery 11 is connected to the ninth port of the multi-port switching valve 1.

Alternatively, in an unillustrated embodiment, the end of the second return conduit 132 that would otherwise be connected to a port of the multi-port switching valve 1 may instead be connected to the condenser-inflow conduit 31 extending from a port of the multi-port switching valve 1 toward the condenser 3.

To implement an internal circulation for thermal management of the traction battery 11, a first bypass conduit 115 bypassing the traction battery 11 is similarly provided on the second branch conduit 113. One end of the first bypass conduit 115 is connected between the first branching point and the traction battery 11, and the other end thereof is connected between the traction battery 11 and the second branching point, thereby forming a traction battery-bypass branching point, at which a bypass-proportional valve 103 is arranged. Here, the bypass-proportional valve 103 is also configured as a three-way proportional valve. Thus, when needed, the coolant can flow within the circulation loop formed by the first bypass conduit 115 and the section of the second branch conduit 113 where the traction battery 11 is located.

The operating principle of the thermal management system according to the third embodiment will now be described with reference to the multi-port switching valve 1, the first proportional valve 101, the second proportional valve 102, and the corresponding conduit structure shown in FIG. 3. Water is exemplarily used as the coolant for illustration purposes.

As shown in FIG. 3, the eleventh port of the multi-port switching valve 1 is connected to the sixth port, thereby supplying chilled water cooled by the heat exchanger 2 to the first inflow conduit 111. The first port of the multi-port switching valve 1 is connected to the seventh port, thereby supplying heated water heated by the condenser 3 and the heater 4 to the third inflow conduit 131. The chilled water can be supplied to the cold core 12 and the traction battery 11 via the first branch conduit 112 and the second branch conduit 113, respectively, with the flow rates regulated by the first proportional valve 101 as required. The heated water can be supplied to the hot core 13 via the second return conduit 132, with the flow rate regulated by the second proportional valve 102 as required. Additionally, the heated water can also be supplied to the traction battery 11 via the fourth branch conduit 133 and the second branch conduit 113 as required. If the fourth branch conduit 133 is not provided or if the second proportional valve 102 is configured as a two-way proportional valve, a heated water conduit cannot be branched out from the second proportional valve 102. In this case, the first port of the multi-port switching valve 1 in FIG. 3 can be connected to the sixth port, and the first proportional valve 101 can be configured to supply only heated water to the traction battery 11, thereby also achieving heating or temperature rise of the traction battery 11. Thus, heated water can be introduced into the hot core 13 to heat it; chilled water can be introduced into the cold core 12 to cool it; heated water can be introduced into the traction battery 11 to heat it (e.g., when the ambient temperature is low, the traction battery 11 needs to be preheated before use to quickly bring it to its optimal operating temperature); or chilled water can be introduced into the traction battery 11 to cool it. Moreover, as can also be seen from FIG. 3, the ninth port of the multi-port switching valve 1 is connected to the tenth port, so that the used chilled water for the cold core 12 and/or the traction battery 11, or the used heated water for the traction battery 11, can return via the first return conduit 114 and the multi-port switching valve 1 back to the heat exchanger 2. Additionally, the eighth port of the multi-port switching valve 1 is connected to the fifth port, and the third port of the multi-port switching valve 1 is connected to the second port, so that the used heated water for the hot core 13 flows via the second bypass conduit 142 to the drive motor 10 and then back to the condenser 3, thereby achieving waste heat recovery.

The thermal management system according to the fourth embodiment shown in FIG. 4 is substantially identical in arrangement to that of the third embodiment. Reference may be made to the description of the third embodiment for similar arrangement structures. The difference lies in the connection method of the second bypass conduit 142 and the related arrangement structure. This connection method and related arrangement structure can be referred to the description of the corresponding structure in the second embodiment.

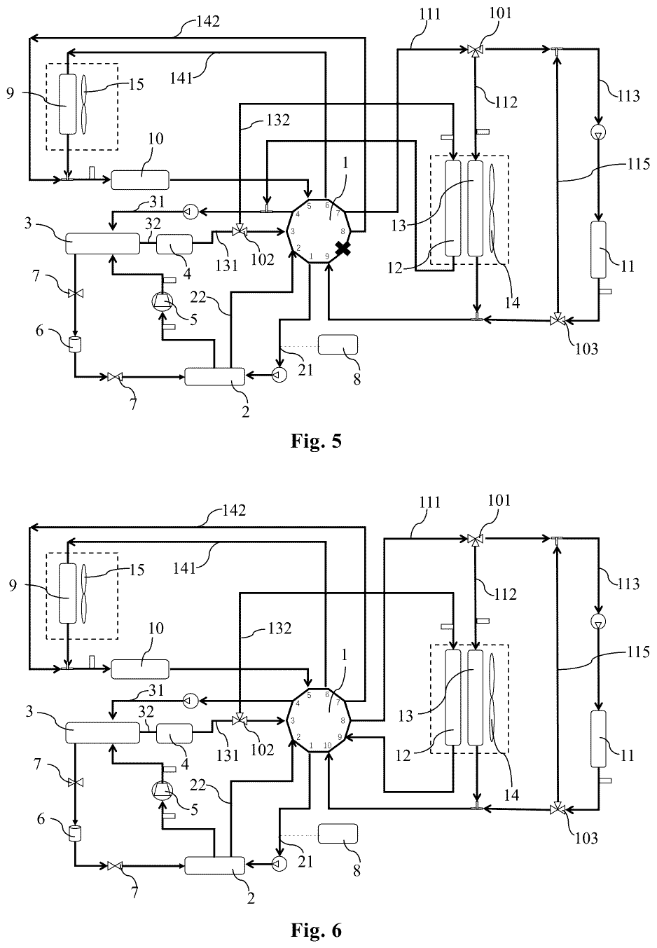

The thermal management system according to the fifth embodiment of the present disclosure will now be described with reference to FIG. 5.

The thermal management system according to the fifth embodiment is substantially identical to that of the third embodiment with respect to the refrigerant circuit, the arrangement structure for waste-heat-recovery-cooling, and the first proportional valve 101 and its related arrangement structure. Reference may be made to the description of the third embodiment for the aforementioned structure. The difference lies in the arrangement structure of the second proportional valve 102 and some additional functional components. The distinction will be mainly described below.

As shown in FIG. 5, the proportional valve assembly includes a second proportional valve 102, which is arranged upstream of the hot core 13 along the flow direction of the coolant. The coolant circuit also includes a third inflow conduit 131 and a second return conduit 132, wherein the hot core 13 is arranged on the second return conduit 132. In this fifth embodiment, the hot core 13 is fluidly connected to the condenser 3 and the heater 4 via the second proportional valve 102 on the inflow side. The second proportional valve 102 is configured as a three-way proportional valve. Unlike the third embodiment, the second proportional valve 102 is arranged on the condenser-outflow conduit 32 extending from the condenser 3 toward a port—namely the third port—of the multi-port switching valve 1. The third inflow conduit 131 is formed by a segment of the condenser-outflow conduit 32. One end of the third inflow conduit 131 is connected to the outlet of the condenser 3 directed toward the multi-port switching valve 1, and the other end thereof is connected to a corresponding inlet of the second proportional valve 102, while one end of the second return conduit 132 is connected to an outlet of the second proportional valve 102, and the other end thereof is connected to the condenser-inflow conduit 31 extending from a port—namely the fourth port—of the multi-port switching valve 1 toward the condenser 3. Thus, neither end of the second return conduit 132, on which the hot core 13 is arranged, is connected to a port of the multi-port switching valve 1. Consequently, one more port of the multi-port switching valve 1 can be saved. For example, compared with the eleven-way valve in the third embodiment, the multi-port switching valve 1 in the fifth embodiment can be configured to have only nine ports in active use. Thus, the multi-port switching valve 1 in the fifth embodiment can be configured as a nine-port switching valve, or as shown in FIG. 5, one port of a ten-port switching valve can be blocked. Consequently, control of the multi-port switching valve 1 becomes easier, reducing the probability of problems with the multi-port switching valve 1 and making the entire system more robust.

As can also be seen in FIG. 5, temperature sensors are additionally provided to detect the temperatures of different components. Unlike the third embodiment shown in FIG. 3, in the fifth embodiment, the first temperature sensor is arranged downstream of the traction battery 11 to detect the temperature of the coolant exiting the traction battery 11, which can better reflect the actual temperature of the traction battery 11. Moreover, as shown in FIG. 5, a second temperature sensor is arranged upstream of the cold core 12 along the flow direction of the coolant, wherein the second temperature sensor is configured to detect the temperature of the coolant flowing toward the cold core 12. Additionally, correspondingly, a third temperature sensor is arranged upstream of the hot core 13 along the flow direction of the coolant, wherein the third temperature sensor is configured to detect the temperature of the coolant flowing toward the hot core 13. On the waste-heat-recovery-cooling conduit 141, a fourth temperature sensor is arranged upstream of the drive motor 10 along the flow direction of the coolant, wherein the fourth temperature sensor is configured to detect the temperature of the coolant flowing toward the drive motor 10, wherein the fourth temperature sensor is arranged between the first radiator-bypass branching point and the drive motor 10. In an unillustrated alternative embodiment, the second bypass conduit 142 may be arranged as shown in FIG. 4. In this case, a bypass-switching valve 104 is additionally provided. In such a scenario, a fifth temperature sensor is arranged upstream of the drive motor 10 along the flow direction of the coolant, wherein the fifth temperature sensor is configured to detect the temperature of the coolant flowing toward the drive motor 10, wherein the fifth temperature sensor is arranged between the third radiator-bypass branching point and the drive motor 10.

As can also be seen from FIG. 5, in the fifth embodiment, temperature-pressure sensors are provided both upstream and downstream of the compressor 5. Moreover, in the fifth embodiment, the coolant supply conduit extending from the coolant reservoir 8 is connected to the heat-exchanger-inflow conduit 21 extending from a port—namely the first port—of the multi-port switching valve 1 toward the heat exchanger 2.

The thermal management system according to the sixth embodiment of the present disclosure will now be described with reference to FIG. 6.

The thermal management system according to the sixth embodiment is substantially identical to that of the fifth embodiment with respect to the refrigerant circuit, the arrangement structure for waste-heat-recovery-cooling, and the first proportional valve 101 and its related arrangement structure. Reference may be made to the description of the fifth embodiment for the aforementioned structure. The difference lies in the connection method of the second return conduit 132. The distinction will be mainly described below.

In the sixth embodiment, one end of the second return conduit 132 is connected to a corresponding outlet of the second proportional valve 102, and the other end thereof is connected to a corresponding port—namely the ninth port—of the multi-port switching valve 1. In this case, one port is saved compared to an eleven-way valve, but one more port is used compared to the multi-port switching valve 1 in the fifth embodiment. This arrangement can also achieve temperature regulation of the hot core 13.

Finally, it should be noted that the arrow directions in the drawings indicate the flow direction of the fluid. Moreover, the term “extending toward” used in the specification also implies the flow direction of the fluid. Additionally, the term “inflow side” refers to the side from which the fluid originates, while the term “return side” refers to the side toward which the fluid flows.

The thicknesses of the elements in the drawings may be exaggerated for clarity. It can also be understood that if an element is said to be on another element, coupled to another element, or connected to another element, then the element may be directly formed on, coupled to, or connected to the other element, or there may be one or more intervening elements between them. Conversely, if the terms “directly on,” “directly coupled to,” and “directly connected to” are used herein, it indicates that there are no intervening elements. Other words used to describe the relationship between elements should be similarly interpreted, such as “between” and “directly between,” “attached” and “directly attached,” “adjacent” and “directly adjacent,” etc.

Terms such as “top,” “bottom,” “above,” “below,” “upper,” and “lower” are used herein to describe the relationship of one element, layer, or region to another as shown in the drawings. It can be understood that these terms should also encompass other orientations of the device beyond those depicted in the drawings.

It can be understood that although terms such as “first,” “second,” etc., may be used herein to describe different elements, these elements should not be limited by these terms. These terms are used only to distinguish one element from another. Thus, a first element may be referred to as a second element without departing from the teachings of the present disclosure concept.

It can also be contemplated that all the exemplary embodiments disclosed herein may be combined arbitrarily. Moreover, all individual technical features disclosed in this application may be combined arbitrarily, provided that the combined technical features are not mutually contradictory. All technically feasible combinations of features are considered to be technical content disclosed in this application.

Finally, it should be pointed out that the above embodiments are intended only to facilitate understanding of the present disclosure and do not limit the scope of protection of the present disclosure. Those skilled in the art may make modifications based on the above embodiments without departing from the scope of protection of the present disclosure.

1. A thermal management system for a vehicle having a refrigerant circuit and a coolant circuit, the refrigerant circuit including a heat exchanger and a condenser which are fluidly connected, the thermal management system comprising:
a multi-port switching valve and a proportional valve assembly connected to the coolant circuit, wherein the heat exchanger and the condenser are each fluidly connected to the multi-port switching valve; and
wherein a plurality of loads are arranged in the coolant circuit, wherein at least part of the plurality of loads are fluidly connected to the multi-port switching valve via the proportional valve assembly, wherein the multi-port switching valve has multiple ports, wherein any two of the multiple ports can be mutually connected inside the multi-port switching valve.

2. The thermal management system for a vehicle according to claim 1, wherein the plurality of loads include a traction battery and a cold core for a passenger compartment of the vehicle, wherein the proportional valve assembly includes a first proportional valve, wherein the traction battery and the cold core are fluidly connected to the multi-port switching valve via the first proportional valve on the inflow side, wherein the first proportional valve is arranged upstream of the traction battery and the cold core along the flow direction of the coolant, wherein the first proportional valve has at least one inlet and at least two outlets, wherein two of the at least two outlets are respectively dedicated to the traction battery and the cold core.

3. The thermal management system for a vehicle according to claim 1, wherein the first proportional valve is configured as a three-way proportional valve.

4. The thermal management system for a vehicle according to claim 2, wherein the traction battery and the cold core are arranged in parallel to form a parallel structure, wherein the parallel structure includes a first branch conduit and a second branch conduit, wherein the coolant circuit includes a first inflow conduit and a first return conduit, the first inflow conduit and the first return conduit are fluidly connected to the multi-port switching valve, wherein the first branch conduit and the second branch conduit branch off from the first inflow conduit at a first branching point on the inflow side and converge into the first return conduit at a second branching point on the return side,
wherein the cold core is arranged on the first branch conduit,
wherein the traction battery is arranged on the second branch conduit,
wherein the first proportional valve is arranged at the first branching point on the inflow side, wherein one end of the first branch conduit and one end of the second branch conduit are respectively connected to corresponding outlets of the first proportional valve and the other ends thereof converge at the second branching point.

5. The thermal management system for a vehicle according to claim 4, wherein one end of the first inflow conduit is connected to a corresponding port of the multi-port switching valve and the other end thereof is connected to a corresponding inlet of the first proportional valve, wherein one end of the first return conduit is connected to a corresponding port of the multi-port switching valve.

6. The thermal management system for a vehicle according to claim 4, wherein a first bypass conduit bypassing the traction battery is provided on the second branch conduit, wherein one end of the first bypass conduit is connected between the first branching point and the traction battery, and the other end thereof is connected between the traction battery and the second branching point, thereby forming a traction battery-bypass branching point, and wherein a bypass-proportional valve is arranged at the battery-bypass branching point.

7. The thermal management system for a vehicle according to claim 6, wherein the bypass-proportional valve is configured as a three-way proportional valve.

8. The thermal management system for a vehicle according to claim 4, wherein the plurality of loads further include a hot core for the passenger compartment of the vehicle, wherein the hot core is also fluidly connected to the multi-port switching valve via the first proportional valve on the inflow side, wherein the first proportional valve is arranged upstream of the hot core along the flow direction of the coolant, wherein the first proportional valve has at least two inlets and at least three outlets, wherein three of the at least three outlets are respectively dedicated to the traction battery, the cold core, and the hot core.

9. The thermal management system for a vehicle according to claim 8, wherein the first proportional valve is configured as a three-position five-way proportional valve.

10. The thermal management system for a vehicle according to claim 8, wherein the coolant circuit includes a second inflow conduit and a third branch conduit,
wherein one end of the second inflow conduit is connected to a corresponding port of the multi-port switching valve and the other end thereof is connected to a corresponding inlet of the first proportional valve,
wherein one end of the third branch conduit is connected to a corresponding outlet of the first proportional valve and the other end thereof is either connected to a corresponding port of the multi-port switching valve or connected to a condenser-inflow conduit extending from a port of the multi-port switching valve toward the condenser,
wherein the hot core is arranged on the third branch conduit.

11. The thermal management system for a vehicle according to claim 4, wherein the plurality of loads further includes a hot core for the passenger compartment of the vehicle, wherein the proportional valve assembly includes a second proportional valve, wherein the second proportional valve is arranged upstream of the hot core along the flow direction of the coolant.

12. The thermal management system for a vehicle according to claim 11, wherein the coolant circuit includes a third inflow conduit and a second return conduit, wherein the hot core is arranged on the second return conduit,
wherein the hot core is fluidly connected to the multi-port switching valve via the second proportional valve on the inflow side, wherein the second proportional valve has at least one inlet and at least one outlet, wherein one end of the third inflow conduit is connected to a corresponding port of the multi-port switching valve and the other end thereof is connected to a corresponding inlet of the second proportional valve, while one end of the second return conduit is connected to a corresponding outlet of the second proportional valve and the other end thereof is either connected to a corresponding port of the multi-port switching valve or connected to a condenser-inflow conduit extending from a port of the multi-port switching valve toward the condenser, or
wherein the hot core is fluidly connected to the condenser via the second proportional valve on the inflow side, wherein the second proportional valve has at least one inlet and at least two outlets, wherein the second proportional valve is arranged on a condenser-outflow conduit extending from the condenser toward a port of the multi-port switching valve, the third inflow conduit is formed by a segment of the condenser-outflow conduit, wherein one end of the third inflow conduit is connected to the outlet of the condenser directed toward the multi-port switching valve and the other end thereof is connected to a corresponding inlet of the second proportional valve, while one end of the second return conduit is connected to a corresponding outlet of the second proportional valve and the other end thereof is either connected to a corresponding port of the multi-port switching valve or connected to a condenser-inflow conduit extending from a port of the multi-port switching valve toward the condenser.

13. The thermal management system for a vehicle according to claim 12, wherein the hot core is fluidly connected to the multi-port switching valve via the second proportional valve on the inflow side, wherein the second proportional valve has at least one inlet and at least two outlets, wherein the coolant circuit further includes a fourth branch conduit, one end of which is connected to a corresponding outlet of the second proportional valve and the other end of which is connected to the second branch conduit, and/or
wherein a heater is arranged on the condenser-outflow conduit, and when the hot core is fluidly connected to the condenser via the second proportional valve on the inflow side, the heater is arranged between the condenser and the second proportional valve, and/or
wherein the second proportional valve is configured as a three-way proportional valve.

14. The thermal management system for a vehicle according to claim 1, wherein the coolant circuit includes a waste-heat-recovery-cooling conduit, both ends of which are respectively connected to corresponding ports of the multi-port switching valve, wherein a radiator is arranged on the waste-heat-recovery-cooling conduit.

15. The thermal management system for a vehicle according to claim 14, wherein a drive motor is also arranged on the waste-heat-recovery-cooling conduit, the drive motor being arranged either upstream or downstream of the radiator along the flow direction of the coolant on the waste-heat-recovery-cooling conduit.

16. The thermal management system for a vehicle according to claim 15, wherein the coolant circuit includes a second bypass conduit, which bypasses the radiator.

17. The thermal management system for a vehicle according to claim 16, wherein one end of the second bypass conduit is connected to a corresponding port of the multi-port switching valve and the other end thereof is connected to the waste-heat-recovery-cooling conduit between the radiator and the drive motor, thereby forming a first radiator-bypass branching point at the connection point between the second bypass conduit and the waste-heat-recovery-cooling conduit.

18. The thermal management system for a vehicle according to claim 16, wherein one end of the second bypass conduit is connected to the waste-heat-recovery-cooling conduit between the inflow-side port of the multi-port switching valve and the radiator, and the other end thereof is connected to the waste-heat-recovery-cooling conduit between the radiator and the drive motor, thereby correspondingly forming a second radiator-bypass branching point on the inflow side and a third radiator-bypass branching point on the return side at the respective connection points between the second bypass conduit and the waste-heat-recovery-cooling conduit, wherein a bypass-switching valve is arranged at the second radiator-bypass branching point.

19. The thermal management system for a vehicle according to claim 18, wherein the bypass-switching valve is configured as a three-way switching valve.

20. A vehicle, wherein the vehicle comprises the thermal management system for a vehicle according to claim 1.
